(19) United States
(12) Patent Application Publication
(10) Pub. No.: US 2020/0284224 A1
(43) Pub. Date: Sep. 10, 2020

(54) HYPERSONIC SUPERCONDUCTING COMBUSTION RAM ACCELERATED MAGNETOHYDRODYNAMIC-DRIVE

(71) Applicant: HyperSpace Propulsion, Inc., Portland, ME (US)

(72) Inventor: Richard H. Lugg, Portland, ME (US)

(21) Appl. No.: 16/742,487

(22) Filed: Jan. 14, 2020

Related U.S. Application Data
(60) Provisional application No. 62/792,184, filed on Jan. 14, 2019.

(51) Int. Cl. F02K 7/16; F02K 3/075; F02C 7/042; F02K 9/78

(52) U.S. Cl. CPC F02K 7/16; F02K 3/075; F05D 2220/80; F02K 9/78; F02C 7/042

(57) ABSTRACT

An aerospace hybrid hypersonic propulsion system which has a common core airflow path through the engine combining subsonic, transonic, supersonics and hypersonic propulsion system and architecture in such a way that five known engine cycles known in the art are configured and connected to operate seamlessly with a hybrid electric and thermal cycle.

### RELATED APPLICATIONS

This application claims rights under 35 U.S.C. § 119(e) from U.S. Patent Application Ser. No. 62/792,184 by the same inventor filed Jan. 14, 2019, the contents of which are incorporated herein by reference.

### FIELD OF THE INVENTION

The invention relates to aircraft, and more particularly, to hypersonic aircraft.

### BACKGROUND OF THE INVENTION

The future hypersonic fighter, or unmanned system, must be fast (Mach 5.0+) to encroach upon heavily protected enemy air space fast, and launch hypersonic missiles, or fire directed energy weapons. For now and into the foreseeable future, speed is the new stealth, with the potential commanding of space and the defense there of, creating the next ruling nation as the global power. A future offensive/defensive hypervelocity fighter with integrated hypersonic air breathing propulsion system, of this magnitude, provides, drastically reduced time-to-target for real-time action in the theatre and a very low probability of intercept. As the threats faced by our military push friendly forces further from high value targets, air war and future space war (requiring SSTO space access) will demand speeds well in excess of Mach 5.0 (preferably in excess of speeds of Mach 8.0) to ensure timely and effective strike in an anti-access/area denial environment/offensive space access-defense environments.

What is needed, therefore, are improved techniques for hypersonic flight.

### SUMMARY OF THE INVENTION

The long-range/stand-off hypersonic fighter (space fighter) of the present invention depends on a Hybrid Turbine Rocket Based Combined Cycle (H-TRBCC) propulsion system, which includes an engine that is an efficient hypersonic “hybrid” air-breather, and for which the turbomachinery includes a first engine system cycle which is shaftless. The ram-scram which comprises the second and third hypersonic engine cycle offers tri-mode combustion, all fully integrated through a subsonic, transonic and supersonic combustion system with the propulsion system on the invention holding a novel electric Magnetohydrodynamic (MHD) augmenting thrust accelerator drive integrated to the aft nozzle. This propulsion system integrates across a single common flow path core turbo-ram-scram-MHD accelerator engine cycles. This feature enables a complete electrically segmented turbomachinery architecture, stage-to-stage; turbine core, compressor, and bypass fan. Mission assurance is achieved with sufficient electric power to segment a multi-engine electric-air breathing cycle architecture, providing unprecedented gains in thermal, aerodynamic and propulsive efficiency. Present engine data, simulations and parametric analysis indicate projected efficiency gains of greater than 65 percent, end to end. Embedded electric power generation utilizing proprietary superconducting generation architecture in the turbine core, at multi-megawatt levels, further achieves plasma combustion, virtual cowl and shock train control and systems, along with electric supercruise derived by an embedded MHD augmenting accelerator drive. These engine systems work in parallel with Electromagnetic Drag Reduction Technology (EDRT) control which powers stealth and drag efficiencies about the air vehicle. These hybrid-electric power and propulsion control technologies redefine aerodynamic flow, bypass air and compressor mass flow efficiencies, and seamlessly integrate the H-TRBCC engine cycles; turbofan-turbojet-ramjet-scramjet. This propulsion system generates not only the highest thrust to weight at lowest volume in a hypersonic TBCC, but also large amounts of electric power overboard which may be generated for the air vehicle (20 MW+) which may be used, for example, in operating directed energy weapons. A large specific power at lowest specific fuel consumption at Mach numbers at Mach 5.0-10.0+ may also be available at a lower volume (engine size) and power density as well. It will be appreciated that the propulsion system of this invention allows for the following advantages. The propulsion system is a hybrid-turbine based combined cycle (H-TRBCC) hypersonic propulsion engine, with an electric based engine cycle integrated to a turbo-ram-scram, and then MHD accelerated augmented thrust drive, with architecture built around a single common flow hollow superconducting shaftless electric core. The propulsion system also includes a fully integrated turbo-ram-scram H-TRBCC in which the engine has a a turbine accelerator cycle at the center of the engine, about the hollow core and uses the tri-mode turbo-ram-scram engine cycle integrated circumferentially about the turbine accelerator engine architecture. This feature removes the need for current “over-under” TBCC hypersonic engine designs. Current over-under turbine accelerator designs are voluminous, overly complex in thrust matching, and combustion cycle integration, high weight count to air frame weight (thus thrust to weight), dead turbine engine weight components as the turbine accelerator, drive thrust to weight ratios down, as it is shut off at Mach 4.0, and there is there is no common flow path. The propulsion system provides a fully integrated hypersonic, multi-engine cycle system; a shaftless, superconducting electrically driven H-TRBCC engine to drive multi-engine cycle performance; and a turbofan-turbojet-ramjet-scramjet.

The propulsion system also is characterized by electrical and integrated engine cycles which provide seamless operation across all Mach numbers from runway lift-off to Mach 1.0 and on up through Mach 8.0. It also provides for electrical segmentation which also allows for the greatest propulsive and thermal efficiency gain stage to stage on the engine cycle core with greater than about a 40 percent improvement in specific fuel consumption

With this propulsion system there is counter-rotation in turbomachinery independent stages with no stators required, thus half the number of fan and compressor components need to be manufactured, dramatically reducing the cost and simplifying the H-TRBCC turbomachinery core.

Reduced Electromotive (EM) drag is also available. On board power from the propulsion system core generates plasma to develop the virtual cowl at the inlet, power ram-scram fuel injection system, power the MHD ring thrust accelerator system of the turbine core and the scramjet exhaust.

The propulsion system also opens the hypersonic engine design space so revolutionary aircraft designs with phenomenal, unprecedented performance can be made possible for the future. The objective of the focused proposed work deals with the first propulsion and power generation stage of superconducting core of the propulsion system which transitions Mach 5.0 thrust and propulsive speed from mechanical and rotating turbomachinery, air compression, combustion and thrust, to ramjet and subsequent scramjet air compression combustion and thrust, thus utilizing high power electricity to sustain plasma injector combustion and mass air flow/shock train management and flow. The H-TRBCC mechanical compression/supersonic air compression, across the Mach number gap from Mach 3.5 to Mach 5.5 integrates a superconducting generator in the turbine rotor aligned in parallel with the ramjet-scramjet tunnel and common mass flow-combustion flow figure as is further described below.

### BRIEF DESCRIPTION OF THE DRAWINGS

FIG. 1 is a cut away perspective view of a preferred embodiment of the propulsion system of the present invention;

FIGS. 2A-2D are cut away views of the single to three-stage superconducting turbine core exemplified with eight-pole superconducting coil propulsion-power architecture with magnetically levitation outer rings portions of the propulsion system shown in FIG. 1, wherein FIGS. 2A, 2B and 2D are perspective views and FIG. 2C is an end view, and for the purpose of clarity FIG. 2A shows only one ring; and

FIG. 3 is a vertical cross sectional view of the propulsion system shown in FIG. 1.

### DETAILED DESCRIPTION

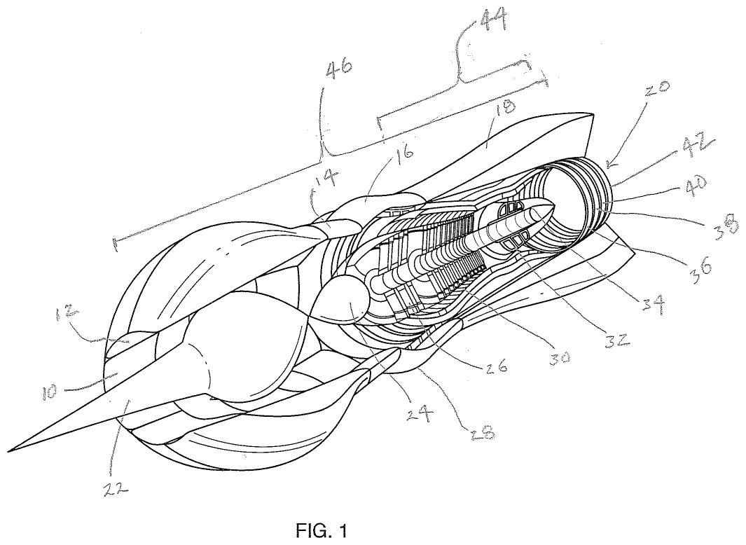

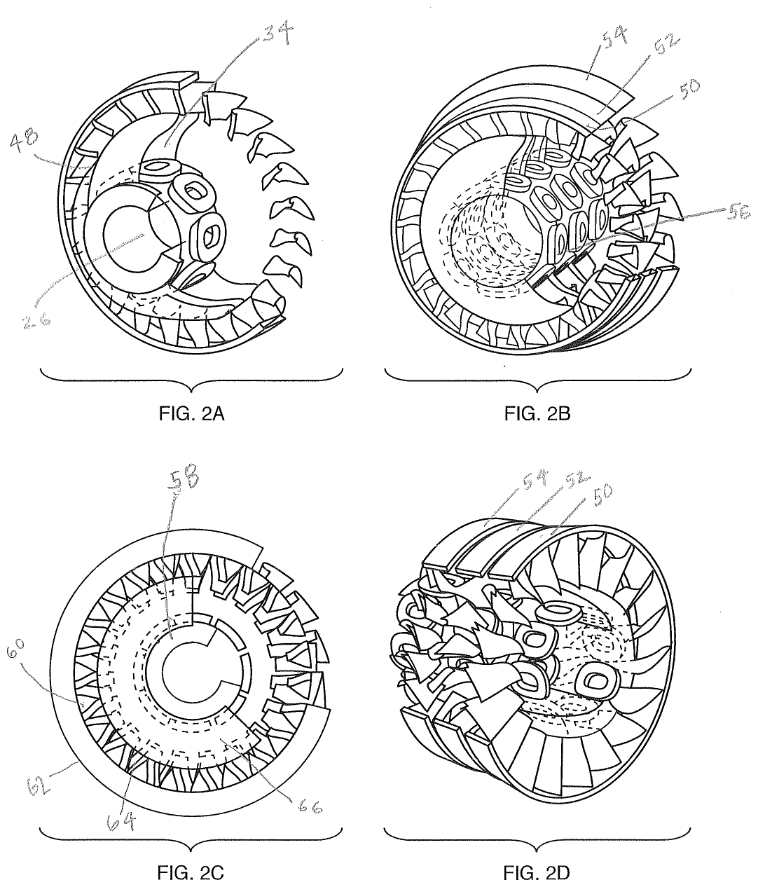

Referring to the drawings and in particular to FIG. 1, the propulsion system includes a turbojet inlet 10, a ramjet scramjet inlet 12, a ram-scram isolator 14, a ram-scram combustor 16, a ram-scram exhaust 18, and a combined cycle turbo ram-scram exhaust 20. The propulsion system also includes a first translational aerospike 22 and a second translational aerospike 24. There is a hollow shaft less core tunnel 26 which is disclosed in greater detail in U.S. Pat. Nos. 8,365,510, 8,446,060, and 8,720,205 to the same inventor, the contents of which are incorporated herein by reference. From the disclosures in these patents, it will be understood that when the engine is in operation, the various rotating elements of the engine are maintained in position by magnetic levitation air bearings located at turbomachinery locations of the dual counter rotating bypass fan magnetic coils. There is also a double tube wall 28 for cryogenic coolant and fuel such as hydrogen. Aft of this tube wall there is a 13-stage superconducting electric compressor 30 after which there is a 3-stage superconducting turbine core 32 which is described in further detail below in connection with FIG. 2. Still referring primarily to FIG. 1, aft of the 3-stage superconducting turbine core there is a superconducting turbine blisk 34 and then four MHD drive accelerator rings 36, 38, 40, and 42, the function of which is also described in further detail below. It will be understood that the overall propulsion system includes a first cycle turbojet cycle 44 which would be employed at lower speeds of from about Mach 1.0 to Mach 5.0 and a second cycle ramjet cycle and third cycle scramjet cycle for speeds of from about above Mach 5.0 to Mach 8.0.

Referring to FIGS. 2A-2D and particularly to FIG. 2A, it will be seen that the 3-stage superconducting turbine core with the turbine blisk 34 surrounds the hollow shaftless core 26 and includes TBCO superconducting racetrack electromagnets. Referring particularly to FIGS. 2B and 2D, the three stages 50, 52, and 54 of the superconducting turbine core with three blisk stages in axial arrangement is shown. Also shown are 8-pole superconducting magnets as at magnet 56. Referring particularly to FIG. 2C, there are hollow shaftless static core housing induction magnets as at magnet 58, outer trunnion ring attaching blades as at blade 60, outer magnetic levitation rings as at ring 62, turbine blades as at blade 64, and inner trunnion ring and blisk 66 which is magnetically levitated to the hollow core.

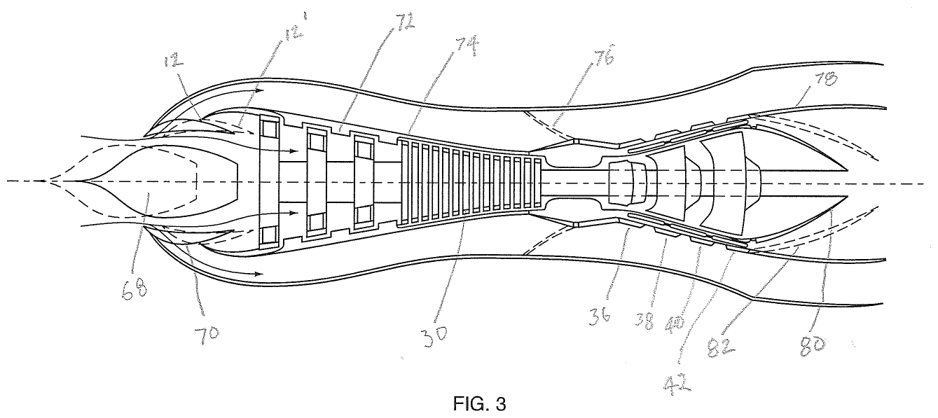

Referring to FIG. 3, the propulsion system also includes a primary linear aerospike nozzle 68, a secondary variable aerospike nozzle 70, magnetic levitation channels 72 and 74, a high speed law speed combustion gate 76, a rocket engine 78, an inner aerospike exhaust ramp 80, and an outer aerospike exhaust ramp 82.

Referring again to FIGS. 1 and 3, to operate the bypass fan and electric compressor for combustion and electricity to run the MHD thrust rings up to Mach 5. The air comes into the turbojet inlet with the first translational aerospike positioned in the rearward position or aft position, and the combustion generates thrust and electricity for the turbine core. The electricity is used to complete the turbojet engine cycle by compressing air in front of the combustor. The air goes around the first translational aerospike which pushes the air into the turbojet core. No air goes into the ramjet and scramjet or rocket cycle. The turbo machinery is limited in combustion and air velocity by a Central Processing Unit (CPU) and sensors and causes the aerospike to move forward to shut off the turbojet inlet at Mach 5 and open the ramjet air inlet. With the ramjet tunnel open air is compressed supersonically for combustion in a separate combustion section different from the turbojet combustor which occurs above Mach 1 while in the turbojet combustion occurs below Mach 1. When the air passes through the ramjet there are no moving parts required to compress air and the tunnel which makes up the ramjet compresses air in the narrowing walls and geometry of the segmented tunnel which includes nine segments.

Referring to FIG. 3, it will be seen that there is a ramjet air inlet 12 which is moved to the scramjet air inlet 12′ by operation of the first translational aerospike. When the CPU and the sensors allow for a Mach 6 condition, the first translational aerospike moves forward to close off the inlet to the ramjet and opens the inlet for the scramjet. The scramjet operates in conjunction with the ramjet in that the supersonic pulse remains the same in that combustion occurs above Mach 1 rather than below Mach 1 so that there is synergy to provide seamless operation from Mach 5 to Mach 10 ending with the scramjet cycle.

At Mach 10 the engines adjust to the flight and mission by adjusting due to CPU and sensory input to begin the rocket cycle to begin the rocket cycle which goes from Mach 10 to Mach 23. The rocket is highly efficient and is not air operating as it is a chemical combustion cycle which uses liquid oxygen and hydrogen brought together for combustion. The MHD drive accelerator operates between the ramjet and Mach 6 and at the scramjet cycle to Mach 13-14. The MHD drive accelerates the flow from the scramjet to accelerate the flow from Mach 10 to Mach 13. The flow from the ramjet and scramjet is charged with the fuel and flow originally charged the plasma carries a positive charge because that flow came into the supersonic combustor from the subsonic combustor of the turbojet where the fuel and flow was originally charged from operating the engine below Mach 5. The exhaust flow of the plasma carries a negative charge. When the exhaust flow reaches the positive plasma ion injection and the positive electromagnetic field of the MHD, the exhaust flow may be accelerated by up to 30 percent of the total thrust of the propulsion system. The object of the MHD ring is to sustain the ion charge to pull the negatively charged exhaust out of the ramjet and scramjet and to add thrust forces to the negatively charged exhaust flow. The purpose of the second translational aerospike is to ensure the effective operation of the rocket cycle once the MHD and ramjet/scramjet cycles are finished. The second translational aerospike moves in conjunction with the first translational aerospike (fore and aft axially) and its purpose is to shut off the central hollow core air flow down the central superconducting turbine core preventing any back pressure buildup at the nozzle/exhaust end of propulsion system while the rocket cycle is operating. There must be not back pressure during rocket cycle operation as this causes turbulent swirl and disrupts rocket specific impulse thrust. Normally prior to rocket cycle operation the very high thrust and Mach numbers to enter space, the turbojet, ramjet and scramjet, along with MHD cycles are operating and the hollow turbine core shaft is used for cooling with the mass flow air flowing through the hollow core.

Critical technology in the practice of the invention will focus on the first turbine propulsion and power generation stage aligned with the ram-scramjet circumferential tunnels. The generator uses high temperature superconducting excitation coils in an 8-pole configuration generating 40.0 MW, 35.0 MW and 30.0 MW respectively, totaling 110.0 MW of power to operate rotating electric turbomachinery, power plasma fuel injection in the ram-scramjet engine cycle, operate the virtual cowl, and power MHD thrust augmentation. The stable operation of the magnets is critical and represents the highest risk component of the system. The superconducting coils need to be mechanically supported in a vacuumed cryostat while subjected to large centripetal forces as well as electromagnetic forces and torque. These forces are substantial as the core rotates at speeds above 10,000 RPM to sustain Mach 5.5 thrust capability matching the beginning of ramjet start and thrust, through Mach 6.0, and transitioning to scramjet cruise up to Mach 10.0. This propulsion process architecture is assisted by plasma fuel injection and the MHD Propulsion Augmentation Drive. In conjunction with the operating turbojet core cycle, aligned to the ram-scram engine cycle analysis, design baseline, critical thermal, mechanical and electromagnetic loads analysis is to be conducted to ensure the seamless operation of all three engine cycles in the propulsion system. This parallels the high risk of magnet design and operation, ensuring the H-TRBCC engine cycle operation is seamless across all Mach numbers of where the electromagnetics power is intimately tied to the multi-engine cycle operation. Of the superconducting power system in the propulsion system, the support structure will conduct heat in the cryostat which will need to be absorbed by the cryo-cooling system. It is therefore paramount to minimize the cryogenic heat load so as to minimize the size and power consumption of the cryo-cooling system. To offset the heat load the exo-skeleton engine casing between the turbomachinery and the ram-scramjet circumferential engine cycle isolators and combustion chambers is hollow and carries the cryogenic nitrogen coolant for the magnets, this offsets the heat load of the propulsion system during flight operation. Simultaneously 2G superconductors have been constantly improving in the past 10 years and are now available in long length with fairly uniform properties from multiple vendors. The current tape performance would allow for the 1st Stage blisk-integrated generator to produce over 40 MW at 50 K. Superconducting electromagnets magnets (SEMs) based upon these conductors are at the core of the proposed technology, of which the electrification of the core sustains the common flow path of the H-TRBCC core of the propulsion system, or alternatively, the ramjet-scramjet can be switched on/off electrically for seamless multi-Mach number operation as an air breather. While numerous HTS motors and generators have been built and successfully tested, there are risks associated with superconducting technology as well as lack of reliability data. Additionally, although there has been decades of TBCC engine development, no design has addressed the joining and powering of three separate air breathing engine cycles and sustain the seamless operation, particularly across the Mach number gap with high power multi-megawatt on-board power generation. Some of the risks include the maintenance of the cryogenic operating temperature of the superconducting excitation coils under nominal thermal and mechanical conditions.

The technical approach to optimizing the practice of this invention may be broken down into four stages: generator design optimization, SCM manufacturing and instrumentation, coil testing, and data analysis and interpretation. These are discussed briefly below.

The generator being integrated within a turbine rotor with significant space constraints, it is important to perform a design optimization of the generator. The optimization will determine the maximum power output of the generator within the space constraints and the limitations of the superconductor. We anticipate the generator to be able to generate power in the range of −750 kW at 77 K and in excess of 3 MW at 30 K. Our initial studies indicate a geometric window based upon a 36 cm diameter blisk. The generator design will be at a level of detail that allows manufacturing of the different components and will include multi-physics simulations, an optimized support structure and cryostat.

SCM manufacturing will require special attention to epoxy impregnation so as to prevent delamination of the superconducting tapes, however, manufacturing will be based upon current best-practices and we do not anticipate the need for significant innovation in this area. Instrumentation will be incorporated into the magnet to monitor the temperature and strain within the magnet during testing.

The most important aspect of the spin testing is demonstrating that the SCM can operate under realistic conditions. This includes mechanical, electrical and thermal loads. Anticipated fault conditions will be simulated in a fracture analysis for catastrophic blisk failure due to high pressure and rotational turbine forces overload, the HP turbine drives the HP compressor in a relative gas turbine environment.

Data analysis and interpretation will focus on the anticipated large volume of data obtained from the spin tests. This data will give one skilled in the art better insights into how the temperature and strain vary within the SCM while spinning. This in turn can be used to validate and improve our models so as to provide a more accurate design tool, for air or ground based applications, as we move to full-scale implementation.

In addition, the data analysis and interpretation will allow one skilled in the art to identify scale-up challenges, risks and required research and development to move forward. This could influence the blisk architecture, geometric constraints based on aerodynamic and thermal turbine engine performance, mechanical or thermal design, the need for new materials, etc.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. An aerospace propulsion system comprising: a shaftless hollow core turbojet engine with a turbojet air inlet and means for opening and closing said turbojet air inlet; and a ramjet engine positioned axially outwardly from the hollow core turbojet engine with a ramjet air inlet and means for opening and closing said ramjet inlet.

2. The aerospace propulsion system of claim 1 wherein a scramjet engine is positioned aft of the ramjet engine and there is a scramjet air inlet.

3. The aerospace propulsion system of claim 1 wherein the means for opening and closing the turbojet air inlet and the ramjet air inlet is an axial translational aerospike which is moveable in a forward direction and an aft direction to open or close the turbojet air inlet and ramjet air inlet.

4. The aerospace propulsion system of claim 2 wherein the means for opening and closing the turbojet air inlet and the ramjet scramjet air inlet is an axial translational aerospike which is moveable in a forward direction and an aft direction to open or close the turbojet air inlet, the ramjet air inlet and the scramjet air inlet.

5. The aerospace propulsion system of claim 4 wherein there is a second axial translational aerospike which is moveable in a forward and aft direction to open and close the shaftless hollow core.

6. The aerospace propulsion system of claim 3 wherein there is a rocket engine aft of the scramjet engine.

7. The aerospace propulsion system of claim 6 wherein the ramjet scramjet air inlet and the scramjet air inlet are closed when the turbojet engine is operating.

8. The aerospace propulsion system of claim 7 wherein the turbojet air inlet is closed when the ramjet or scramjet engine is operating.

9. The aerospace propulsion system of claim 8 wherein the turbojet air inlet, the ramjet air inlet, and the scramjet air inlet are closed when the rocket engine is operating.

10. The aerospace propulsion system of claim 3 wherein the turbojet engine includes a multiple stage axial compressor.

11. The aerospace propulsion system of claim 10 wherein the turbine engine includes a multiple stage turbine core.

12. The aerospace propulsion system of claim 11 wherein there is a ramjet scramjet combustor.

13. The aerospace propulsion system of claim 12 wherein aft of the ramjet scramjet combustor there is a combined cycle turbo ramjet scramjet exhaust.

14. The aerospace propulsion system of claim 13 wherein aft of the combined cycle turbo ramjet scramjet exhaust there is a magnetohydrodynamic accelerator.

15. The aerospace propulsion system of claim 14 wherein the magnetohydrodynamic accelerator comprises a plurality of charged axially arranged rings.

16. An aerospace propulsion system comprising a common core airflow path through the system combining subsonic, transonic, supersonics and hypersonic engines in such a way that a plurality of engine cycles are connected to operate sequentially.

17. A method for operating an aerospace propulsion system comprising the steps of: providing a shaftless hollow core turbojet engine with a turbojet air inlet and means for opening and closing said turbojet air inlet; providing a ramjet engine positioned axially outwardly from the hollow core turbojet engine with a ramjet air inlet and means for opening and closing said ramjet inlet; at a lower initial speed operating the turbojet engine and causing the turbojet air input to be open and the ramjet inlet to be closed; and at a higher subsequent speed operating the ramjet engine and causing the ramjet air input to be open and the turbojet air input to be closed.

18. The method for operating an aerospace propulsion system of claim 17 comprising the further steps of providing a scramjet engine and a scramjet air inlet and operating the scramjet engine and not the ramjet engine or the turbojet engine at an increased speed while the ramjet engine and the turbojet engine are not being operated and the scramjet air inlet is opened and the ramjet air inlet and the turbojet air inlet are each closed.

19. The method for operating an aerospace propulsion system of claim 18 comprising the further step of providing a rocket engine and operating the rocket engine at a still further increased speed while the scramjet engine, the ramjet engine air inlet, the ramjet air inlet, and the turbojet air inlet are each closed.

20. The method of claim 19 comprising the further step of providing an electromagnetic field to accelerate charged exhaust from the ramjet and scramjet
